(19) United States
(12) Patent Application Publication
(10) Pub. No.: US 2006/0233169 A1
(43) Pub. Date: Oct. 19, 2006

(54) Residential ethernet switching apparatus capable of performing time-slot switching and time-slot switching method thereof

(75) Inventors: Sihai Wang, Suwon-si (KR); Kwan-Soo Lee, Seoul (KR); Jun-Ho Koh, Suwon-si (KR); Sang-Ho Kim, Hwaseong-si (KR); Jae-Hun Cho, Seoul (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/406,678

(22) Filed: Apr. 19, 2006

(30) Foreign Application Priority Data
Apr. 19, 2005 (KR) 2005-32313

(51) Int. Cl. H04L 12/56; H04L 12/43

(52) U.S. Cl. 370/389; 370/458

(57) ABSTRACT

A Residential Ethernet switching apparatus for performing time slot switching includes an input unit for receiving frames as input, and a parser for parsing the received frames into asynchronous Ethernet frames (AsyncE frames) and Residential Ethernet frames (ResE frames). An AsyncE switching processor performs a switching operation for an AsyncE frame parsed by the parser. A ResE switching processor performs, according to positions of time slots included in a ResE frame parsed, a virtual MAC (VMAC) processing for the ResE frame The ResE switching processor also performs a switching operation based on a result of the VMAC processing. A multiplexer multiplexes the AsyncE frame switched by the AsyncE switching processor, and the ResE frame switched by the ResE switching processor, for output.

### CLAIM TO PRIORITY

This application claims the benefit under 35 U.S.C. 119(a) of an application entitled “Residential Ethernet Switching Apparatus Capable Of Performing Time-Slot Switching And Time-Slot Switching Method Thereof,” filed in the Korean Intellectual Property Office on Apr. 19, 2005 and assigned Serial No. 2005-32313, the entire contents of which are incorporated herein by reference.

### BACKGROUND OF THE INVENTION

1. Field of the Invention

The present invention relates to Residential Ethernet, and more particularly to a core technology for a Residential Ethernet switching apparatus.

2. Description of the Related Art

Ethernet is the most widely used local area network technology and is now defined as part of the Institute of Electrical and Electronics Engineers (IEEE) 802.3 standard. Ethernet was originally developed by Xerox and has been advanced by Xerox, Digital Equipment Corporation (DEC), Intel, etc.

In conventional Ethernet, competitive access is accomplished by means of a carrier sense multiple access/collision detect (CSMA/CD) protocol stipulated in IEEE 802.3. A service frame of an upper layer is converted to an Ethernet frame while maintaining an inter frame gap (IFG), and the Ethernet frame is transmitted. In this case, upper service frames are transmitted in order of their generation, regardless of type. That is, the Ethernet is a technology generally used when data are transmitted among a plurality of terminals or users.

Such Ethernet has been known to be insufficient for transmitting moving pictures or voice data susceptible to transmission delay, because the Ethernet employs the CSMA/CD scheme in which every Ethernet frame is given the same priority and is competitively transmitted.

In this regard, Residential Ethernet (or isochronous/synchronous Ethernet) has been proposed for use with applications that are susceptible to time and a phase in a limited space, such as moving pictures and voice data susceptible to transmission delay.

Such Residential Ethernet is currently being studied by the IEEE 802.3 RE study group, and is expected to expand the current IEEE 802.3 standard, while aiming at the standard for interface between a computer and audio/video devices.

The Residential Ethernet, which is currently being studied, will not be changed in terms of the basic structure and topology of the current IEEE 802.3 standard.

Although the typical structure and topology of the Residential Ethernet will not be changed, it is necessary to change its switching operation. This is because the transmission unit is changed, which will be described in more detail later.

Generally, the Ethernet apparatus includes two kinds of apparatuses, that is, a terminal apparatus and a switch (or bridge). In this document, slot switching refers to a core technology of a Residential Ethernet switch.

In the current asynchronous Ethernet, an Ethernet frame is the minimum transmission unit in an Ethernet domain. The frame is allocated with one 48-bit MAC (Media Access Control) address, which is used to specify a terminal apparatus.

The conventional Ethernet frame, as seen in FIG. 1, includes a preamble field 11, a destination address (DA) field 12, a source address (SA) field 13, an Ethernet-type (E-type) field 14, a data field 15, and a frame check sequence (FCS) field 16. The preamble field 11 consists of 8 bytes, and represents the start and end of the frame. The destination address field 12 consists of 6 bytes, and represents a MAC address of a destination, to which the frame should be transmitted, and the source address field 13 consists of 6 bytes and represents a MAC address of a station that transmits the frame. The E-type field 14 consists of 2 bytes and represents a protocol type of the frame, and the data field 15 contains data to be transmitted. The FCS field 16 consists of 4 bytes, and is located at the end part of the frame in order to detect an error when information is discretely transmitted through frames during data communication.

According to the Ethernet switching function using such an Ethernet frame, the frame is transmitted from an output port of the source to an input port of a destination, based on the destination address 12 included in a header of the Ethernet frame.

The Ethernet switching function requires a frame switching table for mapping switch ports to MAC addresses. Learning, aging, and searching of switching records can be performed in relation to the frame switching table.

Generally, Ethernet switches include an SRAM for storing a frame switching table and a hash function, which are used to generate a memory access pointer from a MAC address.

However, such an operation of the Ethernet switch is available only in asynchronous Ethernet, and is not available in Residential Ethernet which uses a time slot, instead of an Ethernet frame, as the minimum unit.

According to the switching operation of the Residential Ethernet, one Residential Ethernet frame (ResE frame) having a multicast MAC destination address includes time slots destined to be transmitted to different apparatuses. In this case, the destination of each time slot included in the ResE frame is specified by the position of the time slot, rather than by a destination MAC address.

As described above, the Residential Ethernet requires information about the positions of time slots within a predetermined cycle (i.e., a cycle of 125 μsec) in order to perform the switching operation.

Although the conventional Ethernet switch is designed to detect a destination address of an Ethernet frame and then to output the Ethernet frame to an output port corresponding to the detected destination address, the switching operation of the conventional Ethernet switch does not accommodate a ResE frame.

As described above, the ResE frame includes a plurality of time slots, but no switching scheme for switching these time slots has yet been proposed.

The Residential Ethernet uses time slots, to increase a bandwidth usage rate (BUR) by avoiding encapsulation overhead.

In particular, if an Ethernet frame is used as the minimum transmission unit, bandwidth is wasted due to encapsulation bytes such as those for an Ethernet header.

For instance, each HDTV data stream requires a bandwidth of 20 Mbps, which corresponds to 2.5 kb/cycle or 312 bytes/cycle.

If these bytes are encapsulated into one integrated frame, the length of the frame is 338 bytes, which is a sum of a preamble (8 bytes), AsyncE-Header (14 bytes), data (312 bytes), and FCS (4 bytes), and a gap (InterFrame Gap; IFG) between frames has 12 bytes, thereby requiring a total of 350 bytes. Accordingly, the bandwidth usage rate (BUR) becomes 312/350, i.e., 89%.

If a Residential Ethernet header for Residential Ethernet is included in the frame, or if a relevant application consumes less bandwidth, the bandwidth usage rate (BUR) becomes lower.

A multicast address as a destination address of a ResE frame for the following reasons. First, since Residential Ethernet is frequently used for point-to-multipoint applications, it is effective to use a multicast address as destination address and Residential Ethernet stream indicator for link construction and data transmission. This fact is applied to and verified by an internet protocol (IP) multicast application.

Second, since each ResE frame includes a plurality of time slots, and the time slots have various destinations, it is impossible to establish an appropriate destination address rather than a multicast address.

Therefore, ResE frames use multicast addresses as destination addresses, while asynchronous Ethernet frames (including Internet data and Residential Ethernet control/management frames) use unicast addresses as destination addresses.

However, no switching scheme for frames, including ResE, having different address systems has yet been developed. The need exists to develop a switching scheme for these frames in order to put the Residential Ethernet to practical use.

### SUMMARY OF THE INVENTION

The present invention has been made to solve the above-mentioned problems occurring in the prior art. In one aspect, the present invention provides a Residential Ethernet switching apparatus and method for performing time slot switching that provides a scheme of switching time slots in Residential Ethernet, thereby realizing a Residential Ethernet system.

In another aspect, the present invention provides a Residential Ethernet switching apparatus and method for performing time slot switching in the form of a bundle, so that it is possible to variably allocate bandwidths, thereby ensuring sufficient bandwidths.

In addressing the above-mentioned aspects and in accordance with a further aspect, there is provided a Residential Ethernet switching apparatus for performing time slot switching. The apparatus includes an input unit for receiving frames as input, and a parser for parsing the received frames into asynchronous Ethernet frames (AsyncE frames) and Residential Ethernet frames (ResE frames). An AsyncE switching processor performs a switching operation for an AsyncE frame parsed by the parser. A ResE switching processor performs, according to positions of time slots included in a ResE frame parsed, a virtual MAC (VMAC) processing for the ResE frame. The ResE switching processor also performs a switching operation based on a result of the VMAC processing. A multiplexer multiplexes the AsyncE frame switched by the AsyncE switching processor, and the ResE frame switched by the ResE switching processor, for output.

In accordance with yet another aspect, there is provided a Residential Ethernet switching apparatus for performing time slot switching. It includes an input unit for receiving, as input, a frame of a bit stream, and a parser for parsing the bit stream and for identifying the received frame as either an asynchronous Ethernet frame (AsyncE frame) or a Residential Ethernet frame (ResE frame). A MAC hash unit, in case said received frame is identified as an Async frame, performs a MAC hash operation with respect to the received AsyncE frame. A VMAC processor, in case said received frame is identified as an ResE frame, performs a virtual MAC (VMAC) processing with respect to the received ResE frame, according to positions of time slots included in the received ResE frame. A coupler combines an output of the MAC hash unit with an output of the VMAC processor. A lookup engine receives output of the coupler and respectively uses hashed MAC information and VMAC information in the output of the coupler to look up in a switching table which is stored in a filtering database (DB). A local sink receives a lookup result from the lookup engine. A switching unit receives the lookup result from the lookup engine and respectively performs a switching operation with respect to the AsyncE frame and the ResE frame. An output unit outputs frames switched by means of the switching unit.

In accordance with still another aspect, there is provided a Residential Ethernet switching method for performing time slot switching. The method includes receiving, as input, a frame of a bit stream, parsing the bit stream, and identifying the received frame as either an asynchronous Ethernet frame (AsyncE frame) or a Residential Ethernet frame (ResE frame). If the frame is identified as an Async frame a switching operation is performed with respect to the AsyncE frame; if, on the other hand, the frame is identified as a ResE frame, virtual MAC (VMAC) processing if performed with respect to the ResE frame, according to positions of time slots included in the ResE frame, and a switching operation if performed based on a result of the VMAC processing. The switched AsyncE frame, or the switched ResE frame, is outputted by means of a multiplexer having respective inputs for the switched AsyncE and ResE frames.

In accordance with still another aspect, there is provided a Residential Ethernet switching method for performing time slot switching. The method includes receiving, as input, a frame of a bit stream, parsing the bit stream, and identifying the received frame as either an asynchronous Ethernet frame (AsyncE frame) or a Residential Ethernet frame (ResE frame). In the former case, a MAC hash operation is performed with respect to the received AsyncE frame; in the latter case, virtual MAC (VMAC) processing is performed with respect to the received ResE frame, according to positions of time slots included in the received ResE frame. The hashed MAC information, or the VMAC information, respectively, is used to look up in a switching table. A lookup result is obtained. A switching operation is performed with respect to the received AsyncE or ResE frame, respectively, the switched frame is outputted.

### BRIEF DESCRIPTION OF THE DRAWINGS

The above features and advantages of the present invention will be more apparent from the following detailed description taken in conjunction with the accompanying drawings, in which the same elements are indicated with the same reference numerals or symbols throughout the several views:

FIG. 1 is a format diagram of the structure of a conventional Ethernet frame;

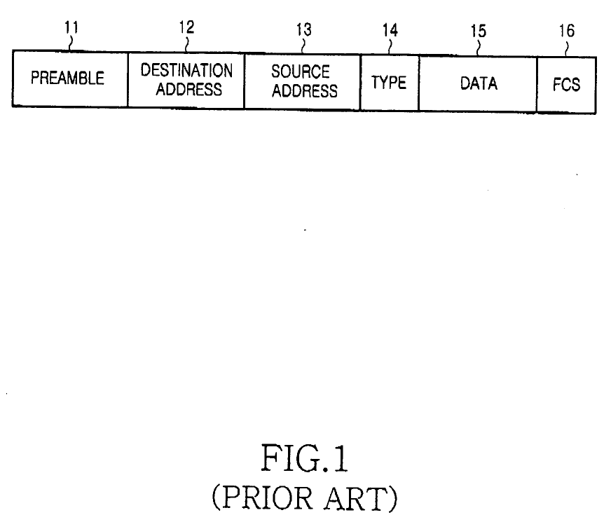

FIG. 2 is a block and flow diagram illustrating an example of the Residential Ethernet switching apparatus according to a first embodiment of the present invention;

FIG. 3 is a flowchart illustrating, by example, operation of the Residential Ethernet switching apparatus according to the first embodiment of the present invention;

FIG. 4 is a block and flow diagram illustrating and example of the Residential Ethernet switching apparatus according to a second embodiment of the present invention;

FIG. 5 is a flowchart illustrating, by example, operation of the Residential Ethernet switching apparatus according to the second embodiment of the present invention;

FIG. 6 is a hierarchical, exploded-view, format diagram illustrating an exemplary scheme for converting a time slot into a VMAC address in the Residential Ethernet according to the present invention;

FIG. 7 is a format diagram illustrating the structure of a ResE filtering database (DB) in a Residential Ethernet switching apparatus according to an embodiment of the present invention; and

FIG. 8 is a format diagram annotated for explaining a method of mapping a plurality of time slots to one switching record in the Residential Ethernet according to an embodiment of the present invention.

### DETAILED DESCRIPTION

In the following discussion of the present invention, detailed description of known functions and configurations incorporated herein is omitted for clarity of presentation.

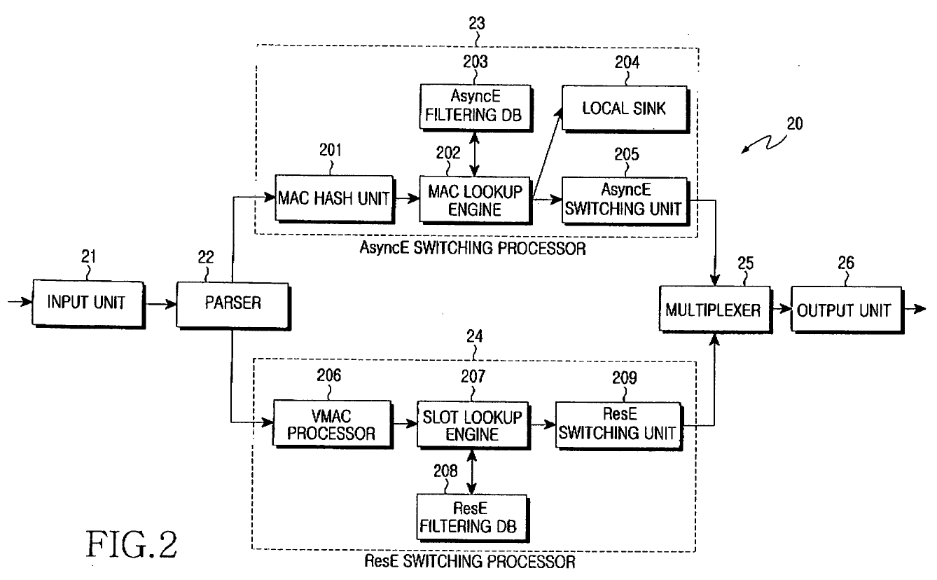

FIG. 2 is a block diagram showing, by way of illustrative and non-limitative example, a Residential Ethernet switching apparatus 20 according to a first embodiment of the present invention.

The Residential Ethernet switching apparatus 20 includes an input unit 21, a parser 22, an AsyncE switching processor 23, a ResE switching processor 24, a multiplexer 25, and an output unit 26. The input unit 21 receives frames from the exterior, and the parser 22 parses the received frames into Residential Ethernet frames (ResE frames) and asynchronous Ethernet frames (AsyncE frames). The AsyncE switching processor 23 performs a switching operation with respect to the parsed AsyncE frame, and the ResE switching processor 24 performs a switching operation with respect to the parsed ResE frame. The multiplexer 25 multiplexes the switched AsyncE frame and the switched ResE frame. The output unit 26 outputs the multiplexed frame.

The AsyncE switching processor 23 includes a MAC hash unit 201, a MAC lookup engine 202, an AsyncE filtering database (DB) 203, a local sink 204, and an AsyncE switching unit 205. The MAC hash unit 201 performs a MAC hash processing by using information in a destination address field included in the header of the parsed AsyncE frame, thereby producing hashed MAC information. The MAC lookup engine 202 uses the hashed MAC information to look up in a switching table that is included in the AsyncE filtering DB 203. The AsyncE filtering DB 203 stores the switching table in relation to AsyncE frames. The local sink 204 receives the lookup result from the MAC lookup engine 202. The AsyncE switching unit 205 also receives the lookup result from the MAC lookup engine 202, and performs a switching operation with respect to the parsed AsyncE frame.

The ResE switching processor 24 includes a VMAC processor 206, a slot lookup engine 207, a ResE filtering DB 208, and a ResE switching unit 209. The VMAC processor 206 performs virtual MAC (VMAC) processing with respect to time slots, according to time slot position information of the parsed ResE frame. Using the VMAC information, the slot lookup engine 207 looks up in a switching table included in the ResE filtering DB 208. The ResE filtering DB 208 stores the switching table in relation to VMAC addresses. The ResE switching unit 209 receives the lookup result from the slot lookup engine 207, and switches time slots of the parsed ResE frame.

Herein, switching of the time slots means transmission of all input time slots to corresponding output positions. The output positions include output ports and time slot positions corrected so as to meet with the required delay and jitter performance.

As shown in FIG. 2, according to an embodiment of the present invention, the Residential Ethernet switching apparatus 20 includes a set of additional time-slot switching modules for switching time slots, as well as the existing AsyncE-frame switching modules.

In particular, the AsyncE switching processor 23 represents the existing AsyncE frame switching modules, and the ResE switching processor 24 represents additional time-slot switching modules added for switching time slots.

As described above, AsyncE frames and ResE frames are processed and transmitted by the AsyncE switching processor 23 and ResE switching processor 24, respectively. Backward compatibility is afforded, in that is unnecessary to change the existing constructions of the modules for switching AsyncE frames.

AsyncE frames and ResE frames thus have different routes from input to output in the Residential Ethernet switching apparatus 20 according to the present invention, thereby simply ensuring delay and jitter performance in Residential Ethernet.

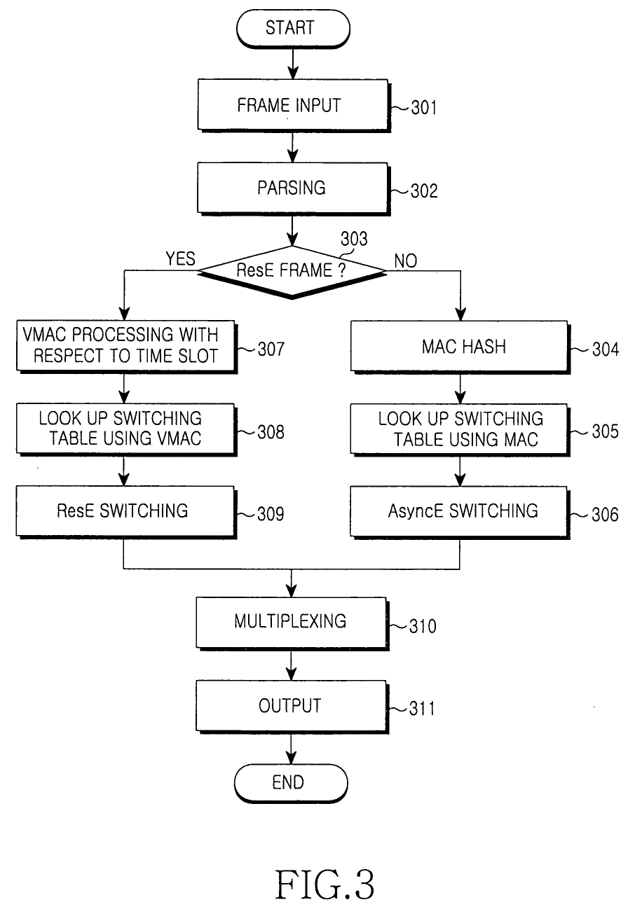

FIG. 3 shows exemplary operation of the Residential Ethernet 20 according to the first embodiment of the present invention.

A frame is received from the exterior in step 301, and the received frame is parsed into an AsyncE frame and a ResE frame in step 302.

It is then determined if the parsed frame is a ResE frame in step 303. If it is determined that the parsed frame is not a ResE frame, a MAC hash processing is performed with respect to the received frame by using information of a destination address field included in the header of the parsed AsyncE frame (step 304). Then, a switching table in the AsyncE filtering DB 203 is looked up by using hash-processed MAC information (step 305), and a switching operation is performed with respect to the parsed AsyncE frame (step 306).

When, on the other hand, it is determined in step 303 that the parsed frame is a ResE frame, time slots are subjected to a virtual MAC (VMAC) processing according to time-slot position information of the parsed ResE frame (step 307).

A switching table in the ResE filtering DB 208 is looked up by using VMAC information (step 308), and a switching operation is performed with respect to the time slots of the ResE frame (step 309).

Next, the switched AsyncE frame and the switched ResE frame are multiplexed in step 310, and the multiplexed frame is output in step 311.

As described above, according to the first embodiment of the present invention, a VMAC processing is performed with respect to time slots in order to switch the time slots included in a ResE frame.

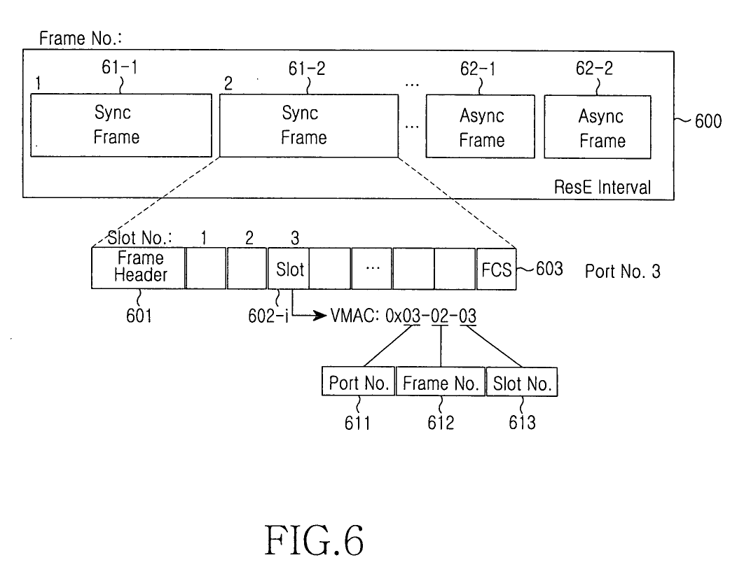

Due to its importance, the VMAC processing is described in more detail with reference to FIG. 6.

FIG. 6 depicts an example of a scheme for converting a time slot into a VMAC address in the Residential Ethernet according to the present invention.

In FIG. 6, one cycle 600 of the Residential Ethernet according to the present invention is shown.

One cycle 600 in the Residential Ethernet includes a plurality of ResE frames 61-1, 61-2, and a plurality of AsyncE frames 62-1, 62-2.

Each of the ResE frames 61-1, 61-2 includes a frame header 601, a plurality of time slots 602-i, and a frame check sequence (FCS) field 603 for detecting a frame transmission error.

Each of the time slots is converted into a VMAC address by using a port number 611, a frame number 612, and a slot number 613.

Generally, in order to exactly locate one time slot, four parameters are required. These are a cycle number, a port number, a frame number and a slot number.

Typically, a real-time data stream refers to a long interval data transmission, and includes time slots having predetermined byte lengths and positions. Such a structure is maintained in a long cycle length (i.e., in a plurality of cycles).

The cycle number is therefore unnecessary in determining the position of a time slot; instead, the position of a time slot can be determined by using merely the port number, the frame number, and the slot number.

When it is assumed that the frame and slot numbers each consist of a one-byte binary number, a total of 2¹⁶−1 slots are allocated for each port, which is sufficient for even a 10 Gbps link in which a maximum of 39,063 slots are transmitted during one cycle.

According to an embodiment of the present invention, a VMAC address is realized by a port number, a frame number, and a slot number.

For instance, as shown in FIG. 6, when one time slot is positioned corresponding to a third port, a second frame and a third slot, its VMAC address becomes 0x03.02.03. Therefore, the position of each time slot can be expressed as a unique VMAC address.

The slot lookup engine 207 for looking up VMAC-processed time slots will now be described in detail.

First, each time slot has different VMAC addresses (or different positions) at the input port and the output port in the switching apparatus 20. These VMAC addresses are respectively named a source VMAC (SVMAC) address and a destination VMAC (DVMAC) address.

According to an embodiment of the present invention, since each ResE frame is a multicast frame, one source frame may be mapped to a plurality of destination frames, but one destination frame must have only one source frame.

The slot lookup engine 207 looks up a source VMAC address by using a destination VMAC address. As described above, similarly to the MAC lookup engine 202 using a hash result of a destination MAC address, the slot lookup engine 207 uses a DVMAC address as an address pointer for a slot switching table in order to find a corresponding SVMAC address.

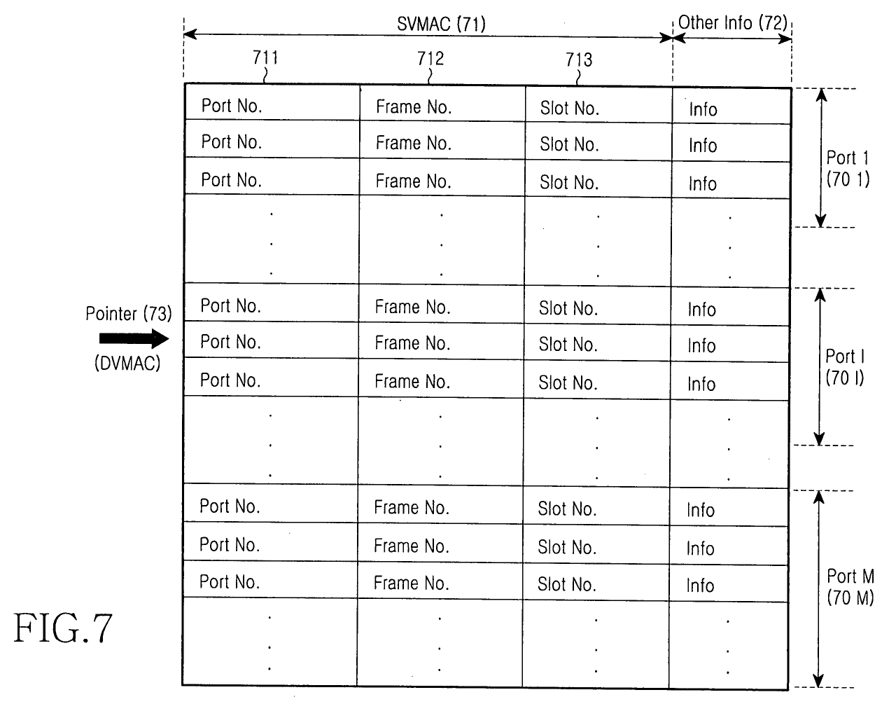

The slot lookup engine 207 looks up a SVMAC address from the ResE filtering DB 208 storing a slot switching table. FIG. 7 illustrates an example of the structure of the ResE filtering DB 208 in the Residential Ethernet switching apparatus 20.

Referring to FIG. 7, data recorded in the ResE filtering DB 208 are classified into two parts: SVMAC 71 and management information 72. These are used for record aging and other operations. The ResE filtering DB 208 is similar, in structure, to the AsyncE filtering DB 203, and record learning and aging functions also are similar to those of the AsyncE filtering DB 203.

According to an embodiment of the present invention, while a ResE link is being constructed, corresponding switching records are learned and stored in the ResE filtering DB 208.

When the switching apparatus 20 receives a ResE-link release command, or when a ResE link remains inactive for a predetermined time period, the switching apparatus deletes the corresponding switching record(s).

The operation of the ResE switching unit 209 will now be described in detail.

Generally, commercial asynchronous Ethernet switches employ three switch fabric design schemes: a shared memory scheme, a shared bus scheme, and a crossbar scheme.

An exemplary ResE switching unit 209 according to an embodiment of the present invention employs a shared memory scheme modified to support Residential Ethernet.

First, all time slots within each cycle are stored in a fixed position of a memory according to SVMAC addresses. The time slots can therefore be easily and individually allocated based on the SVMAC addresses.

All pointers of the time slots are stored in an order of DVMAC addresses in a ResE slot switching table.

Since the relationship between DVMAC addresses and SVMAC addresses is fixed, a slot switching table belonging to each output port may serve as memory pointers of an output port slot queue (i.e. output buffer), so that it is unnecessary to forward the memory pointers of the time slots corresponding to the output port slot queue.

Transmission of time slots through one output port within a predetermined cycle means that the slot switching records are picked up one by one, and corresponding slot data are transmitted by using the picked-up slot switching record as a pointer for addressing the corresponding slot data from a memory.

When the above-mentioned operation is performed in the switching apparatus shown in FIG. 2, each time slot has a SVMAC address obtained from its position information through the VMAC processor 206. Then, the time slots are stored in a shared memory (including the ResE filtering DB 208) based on SVMAC addresses. Next, the slot lookup engine 207 searches the ResE filtering DB 208 by using DVMAC addresses. Consequently, corresponding time slots are patched and are transmitted to an output buffer for ResE switching. Herein, it is assumed that the output buffer is included in the slot lookup engine 207.

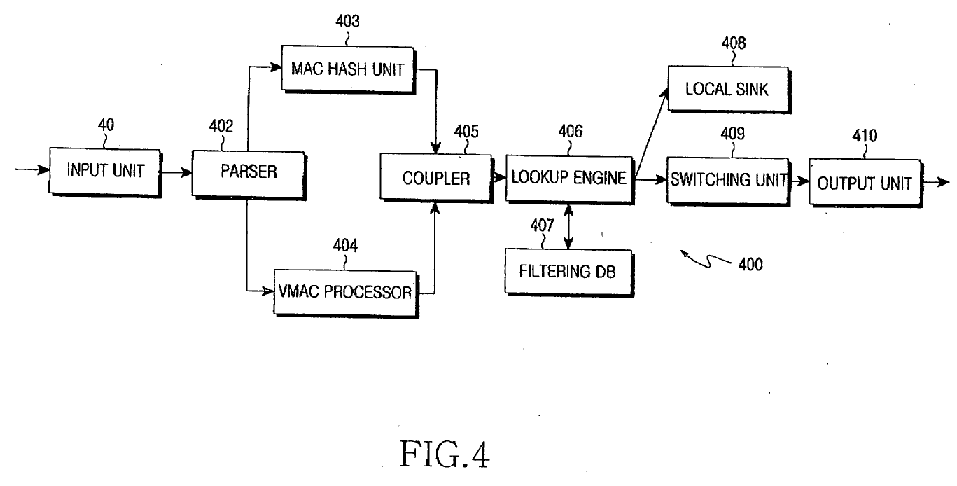

When the AsyncE switching unit 205 uses a shared memory design and the AsyncE filtering DB 203 uses a hash table in the AsyncE switching processor 23 shown in FIG. 2, a plurality of duplicated components may be omitted as shown in FIG. 4 according to a second embodiment of the present invention, thereby enabling the design and manufacture of a low-cost switching apparatus.

The Residential Ethernet switching apparatus 400 according to the second embodiment of the present invention, seen in FIG. 4, includes an input unit 401, a parser 402, a MAC hash unit 403, a VMAC processor 404, a coupler 405, a lookup engine 406, a filtering DB 407, a local sink 408, a switching unit 409, and an output unit 410. The input unit 401 receives frames from the exterior, and the parser 402 parses the received frames into an AsyncE frame and a ResE frame. The MAC hash unit 403 performs a MAC hash operation on the parsed AsyncE frame, and the VMAC processor 404 performs VMAC processing on time slots of the parsed ResE frame according to their respective time slot position information. The coupler 405 combines the output of the MAC hash unit 403 with the output of the VMAC processor 404. The lookup engine 406 looks up a switching table of the filtering DB 407 by using hashed MAC information and VMAC information, and the filtering DB 407 stores the switching table for the AsyncE frame and ResE frame. The local sink 408 receives the lookup result from the lookup engine 406, and the switching unit 409 receives the lookup result from the lookup engine 406 and performs a switching operation with respect to the parsed AsyncE frame. The output unit 410 outputs the frame transmitted through the switching unit 409.

A ResE filtering DB has the same format as an AsyncE filtering DB, so these DBs and the lookup engine can be integrated into one module.

In Residential Ethernet, the ResE switching unit entails less operation than the AsyncE switching unit, and it is not needed to be dynamically copied with an output. This is because the pointers of time slots in a shared memory are always fixedly stored in a slot switching table after a ResE link is constructed, and such a storage state is maintained until the ResE link is released or is aged. Accordingly, the DBs and the lookup engine can be easily integrated.

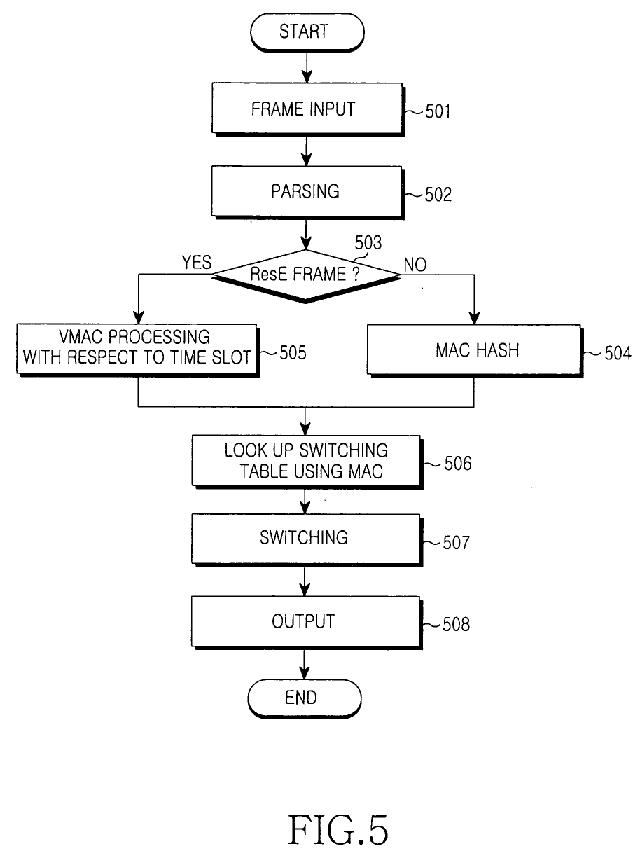

FIG. 5 is a flowchart illustrating the operation of the Residential Ethernet switching apparatus 400 according to the second embodiment of the present invention.

A frame is received from the exterior as part of a bit stream in step 501, and the received frame is parsed from the bit stream and identified as one of an AsyncE frame and a ResE frame in step 502.

If it is determined that the parsed frame is not a ResE frame (step 503), a MAC hash processing is performed with respect to the received frame by using information of a destination address field included in a header of the parsed AsyncE frame (step 504).

On the other hand, when it is determined in step 503 that the parsed frame is a ResE frame, time slots are subjected to a virtual MAC (VMAC) processing according to time-slot position information of the parsed ResE frame (step 505).

Then, a switching table in the filtering DB 407 is looked up by using either VMAC information or hashed MAC information (step 506), and a switching operation is performed with respect to the AsyncE frame and the time slots of the ResE frame (step 507), thereby outputting the switched frames (step 508).

In order to efficiently use bandwidth in such a Residential Ethernet, the present invention provides a method of reducing the size of the slot switching table.

Since the minimum switching unit of the Residential Ethernet is a 4-byte time slot and every time slot in a cycle of 125 μsec has a switching record in a one-to-one mapping manner, the size of the slot switching table is very large.

For instance, a 16-port 1 Gbps ResE-capable switch requires a capacity for a maximum of 62,500 switching records, which is larger than that of any one of the AsyncE switching tables.

Some ResE slots can be used in the form of a bundle in one ResE link in order to provide a higher bandwidth, but it is impossible to further increase the size of a slot when taking bandwidth granularity into consideration.

Actually, it is almost impossible for all or most of the applications to use the minimum bandwidth granularity.

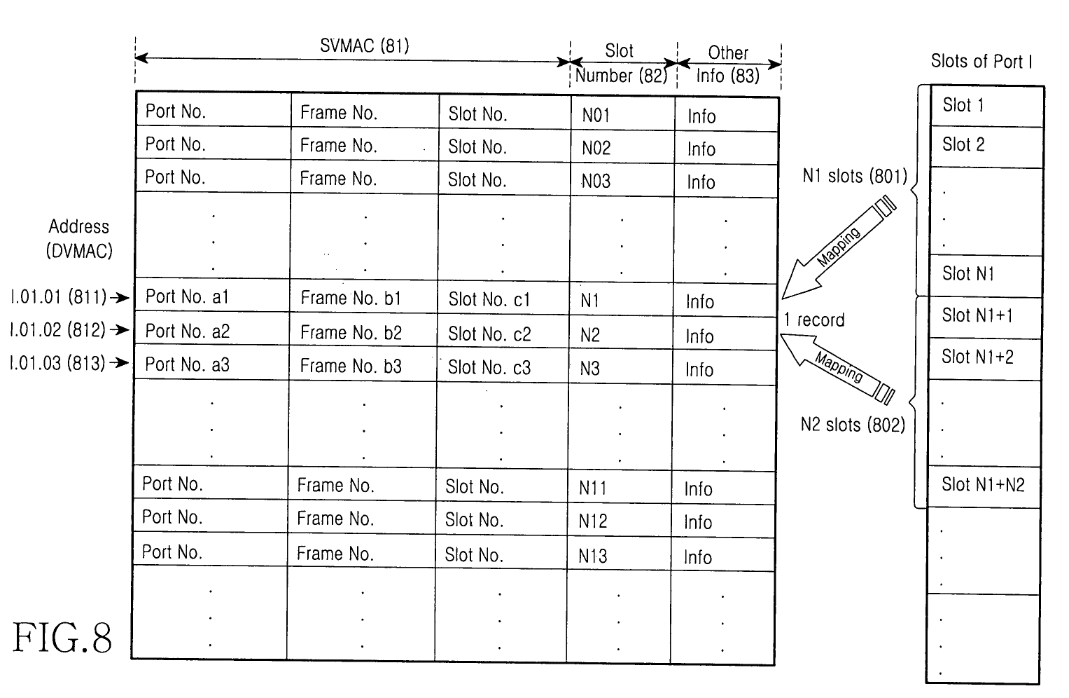

A method for reducing the size of the slot switching table without sacrifice of bandwidth granularity is shown in FIG. 8. Herein, each slot switching record represents a plurality of slot switching information.

FIG. 8 demonstrates an example of a method for mapping a plurality of time slots to one switching record in the Residential Ethernet according to an embodiment of the present invention.

A mapping scheme shown in FIG. 8 is named “non-linear N-to-one mapping”.

Each time slot number representing bandwidth is also stored in the slot switching table.

For instance, referring to FIG. 8, a slot switching record of “I, 01, 01” represents a switching record of a slot bundle when the initial slot position corresponds to the I^{th} port, the first frame and the first slot and the total number of slots is N1.

When the switching apparatus patches the slot switching record of “I, 01, 01”, a slot bundle (N1 slots) 801 starting from an SVMAC address (a1, b1, c1) is continuously forwarded to a DVMAC address (I, 01, 01) 811.

Herein, it should be noted that a slot switching record of “I, 01, 02” represents switching information of a slot bundle (N2 slots) 802 starting from a DVMAC address (I, 01, N1+1).

In this case, in order to generate the switching record of the DVMAC address (I, 01, N1+1), it is necessary to calculate “(I, 01, N1+1)−(N1−1)”. If the position of the bundle is fixed, the result value of the calculation can be easily obtained.

Generally, the number of slots included in each switching record N1, N2, N3, etc. is predetermined, and may be dynamically changed in theory. However, dynamic change is not recommended, because it may make the design of the switching apparatus complicated.

Using switching information for a slot bundle according to the mapping scheme in FIG. 8, the bandwidth allocation of a ResE application becomes variable, owing to the combination between bundles having different sizes, as well as the definition of bundle, and the size of the switching table can be significantly reduced.

For example, a 16-port 1 Gbps ResE-capable switch has switching records corresponding to total 62,500 slots in the case of one-to-one mapping.

If 128 bundles (20 Mbps for HDTV) having 80 slots, 512 bundles (8 Mbps) having 32 slots, 2,560 bundles (1.5 Mbps for CD audio) having 6 slots, and reserved 20,516 bundles having 1 slot are allocated, the number of switching records is reduced to less than 24,000.

As described above, the present invention provides a method for switching time slots in the Residential Ethernet, thereby efficiently realizing the Residential Ethernet system.

In addition, the present invention performs the time slot switching by bundling the slots, so it is possible to variably allocate bandwidths, thereby ensuring sufficient bandwidths.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A Residential Ethernet switching apparatus for performing time slot switching, comprising:
an input unit for receiving frames as input;
a parser for parsing the received frames into asynchronous Ethernet frames (AsyncE frames) and Residential Ethernet frames (ResE frames);
an AsyncE switching processor for performing a switching operation for an AsyncE frame parsed by the parser;
a ResE switching processor for performing, according to positions of time slots included in a ResE frame parsed by said parser, a virtual MAC (VMAC) processing for the ResE frame parsed by the parser and for performing a switching operation based on a result of the VMAC processing;
a multiplexer for multiplexing the AsyncE frame switched by the AsyncE switching processor and the ResE frame switched by the ResE switching processor; and
an output unit for outputting a frame multiplexed by the multiplexer.

2. The Residential Ethernet switching apparatus as claimed in claim 1, wherein position information of said time slots that is used in said VMAC processing includes a port number, a frame number, and a slot number with respect to each time slot.

3. The Residential Ethernet switching apparatus as claimed in claim 2, wherein the ResE switching processor is configured such that a VMAC address through the VMAC processing is specified as a unique value for each of said time slots within one cycle of 125 μsec.

4. The Residential Ethernet switching apparatus as claimed in claim 1, wherein the ResE switching processor comprises:
a VMAC processor for performing virtual MAC (VMAC) processing with respect to said time slots, according to position information of said time slots;
a slot lookup engine for using VMAC information obtained by the VMAC processor to look up in a switching table included in a ResE filtering database (DB);
the ResE filtering DB for storing the switching table in relation to VMAC addresses; and
a ResE switching unit for receiving a lookup result from the slot lookup engine, and switching said time slots.

5. The Residential Ethernet switching apparatus as claimed in claim 4, wherein each of said time slots processed by the VMAC processor has, by virtue of its position in a cycle, a source VMAC (SVMAC) address and a destination VMAC (DVMAC) address at an input port and output port, respectively, of said apparatus, and the ResE filtering DB stores SVMAC information for said each of said time slots in a respective switching record in a slot switching table.

6. The Residential Ethernet switching apparatus as claimed in claim 5, wherein the ResE filtering DB further stores management information, which is used for record aging of the stored information and another operation.

7. The Residential Ethernet switching apparatus as claimed in claim 5, wherein the storing in the ResE filtering DB is such that at least one of said respective switching records is mapped to a plurality of said time slots so as to serve as a respective switching record for a slot bundle comprised of said plurality.

8. The Residential Ethernet switching apparatus as claimed in claim 5, wherein the slot lookup engine uses the DVMAC address as an address pointer for said switching table in order to find a corresponding SVMAC address.

9. The Residential Ethernet switching apparatus as claimed in claim 8, wherein the ResE switching unit performs a switching operation based on a shared memory design scheme.

10. The Residential Ethernet switching apparatus as claimed in claim 9, wherein the ResE switching unit allocates all time slots of respective ones of said received frames input into said apparatus within a predetermined cycle to fixed positions of a memory based on the SVMAC address, and all of the DVMAC address pointers for said all time slots are stored in a DVMAC-address order in said slot switching table stored in the ResE filtering DB.

11. The Residential Ethernet switching apparatus as claimed in claim 10, wherein the ResE switching unit does not forward a memory pointer of a time slot from among said time slots since relationship between DVMAC and SVMAC addresses in said slot switching table is fixed.

12. A Residential Ethernet switching apparatus for performing time slot switching, comprising:
an input unit for receiving, as input, a frame of a bit stream;
a parser for parsing the bit stream and for identifying the received frame as one of an asynchronous Ethernet frame (AsyncE frame) and a Residential Ethernet frame (ResE frame);
a MAC hash unit for, in case said received frame is identified as an Async frame, performing a MAC hash operation with respect to the received AsyncE frame;
a VMAC processor for, in case said received frame is identified as an ResE frame, performing a virtual MAC (VMAC) processing with respect to the received ResE frame, according to positions of time slots included in said received ResE frame;
a coupler for combining an output of the MAC hash unit with an output of the VMAC processor;
a lookup engine for receiving output of the coupler and for respectively using hashed MAC information and VMAC information in said output of the coupler to look up in a switching table of a filtering database (DB);
said filtering DB for storing said switching table;
a local sink for receiving a lookup result from the lookup engine;
a switching unit for receiving the lookup result from the lookup engine and respectively performing a switching operation with respect to the AsyncE frame and the ResE frame; and
an output unit for outputting frames switched by means of the switching unit.

13. A Residential Ethernet switching method for performing time slot switching, said method comprising the acts of:
1) receiving, as input, a frame of a bit stream;
2) parsing the bit stream, and identifying the received frame as one of an asynchronous Ethernet frame (AsyncE frame) and a Residential Ethernet frame (ResE frame);
3) in case said received frame is identified as an Async frame, performing a switching operation with respect to the received AsyncE frame;
4) in case said received frame is identified as a ResE frame, performing virtual MAC (VMAC) processing with respect to the received ResE frame, according to positions of time slots included in said received ResE frame, and performing a switching operation based on a result of the VMAC processing; and
5) outputting respectively the switched AsyncE frame, or the switched ResE frame, by means of a multiplexer having respective inputs for said switched AsyncE and ResE frames.

14. The method as claimed in claim 13, wherein position information of said time slots includes a port number, a frame number, and a slot number with respect to each of said time slots.

15. The method as claimed in claim 14, wherein a VMAC address obtained through the VMAC processing is specified as a unique value for each of said time slots within one cycle of 125 μsec.

16. The method as claimed in claim 13, wherein the act 4) comprises the sub-acts of:
a) using VMAC information obtained through said VMAC processing to look up in a slot switching table included in a ResE filtering DB; and
b) receiving a lookup result obtained by the looking up, and switching said time slots based upon the looked-up result.

17. The method as claimed in claim 16, wherein said performing of said VMAC processing classifies VMAC addresses of said time slots processed in said VMAC processing respectively into one of a source VMAC (SVMAC) address and a destination VMAC (DVMAC) address according to input and output of each respective one of said time slots, and SVMAC information for said each respective one of said time slots in said VMAC processing are collectively stored as respective switching records in said slot switching table.

18. The method as claimed in claim 17, wherein the slot switching table further stores management information, which is used for record aging of the stored information and another operation.

19. The method as claimed in claim 17, wherein the looking up comprises using the DVMAC address as an address pointer for the slot switching table, in order to find a corresponding SVMAC address.

20. The method as claimed in claim 19, wherein the act b) comprises performing a switching operation based on a shared memory design scheme.

21. The method as claimed in claim 17, wherein at least one of said switching records is mapped to a plurality of said time slots so as to serve as a respective switching record for a slot bundle comprised of said plurality.

22. The method as claimed in claim 21, wherein the act b) comprises:
based on SVMAC address, allocating to fixed positions of a memory all time slots input within a predetermined cycle; and
storing in a DVMAC-address order in the slot switching table stored in the ResE filtering DB, all pointers for said time slots input within said cycle.

23. The method as claimed in claim 22, wherein the act b) comprises not forwarding a memory pointer of the time slot since relationship between DVMAC and SVMAC addresses in said slot switching table is fixed.

24. The method as claimed in claim 23, wherein said relationship remains fixed until a ResE link is released or is aged.

25. A Residential Ethernet switching method for performing time slot switching, the method comprising the steps of:
1) receiving, as input, a frame of a bit stream;
2) parsing the bit stream, and identifying the received frame as one of an asynchronous Ethernet frame (AsyncE frame) and a Residential Ethernet frame (ResE frame);
3) in case said received frame is identified as an Async frame, performing a MAC hash operation with respect to the received AsyncE frame;
4) in case said received frame is identified as a ResE frame, performing virtual MAC (VMAC) processing with respect to the received ResE frame, according to positions of time slots included in said received ResE frame;
5) using, respectively, the hashed MAC information, or the VMAC information, to look up in a switching table; and
6) receiving a lookup result obtained through the looking up; performing a switching operation with respect to said received AsyncE frame, or said received ResE frame, respectively; and outputting the switched frame.
